(19) United States
(12) Patent Application Publication
(10) Pub. No.: US 2013/0133258 A1
(43) Pub. Date: May 30, 2013

(54) MULTILAYER ASSEMBLY OF FLUID PERMEABLE GEOMATRIX MATERIAL FOR USE IN VEGETATED ECO-SYSTEM

(71) Applicant: Donald E. Carter, Terrebonne, OR (US)

(72) Inventor: Donald E. Carter, Terrebonne, OR (US)

(73) Assignee: CGT, INC., Portland, OR (US)

(21) Appl. No.: 13/643,532

(22) PCT Filed: Apr. 25, 2011
(86) PCT No.: PCT/US11/33788

§ 371 Date: Dec. 31, 2012

Related U.S. Application Data
(60) Provisional application No. 61/328,109, filed on Apr. 26, 2010.

(51) Int. Cl. A01G 31/00

(52) U.S. Cl. CPC A01G 31/001
USPC 47/59 S

(57) ABSTRACT

A multilayer assembly (10) for use in a vegetated eco-roof or wall system includes layers of progressively permeable geomatrix material. Preferred embodiments of the multilayer assembly are composed of a filtration layer (22) of a nonwoven type positioned between a three-dimensional drainage/aeration base layer (24) and a growing media support layer (26). The sizes and structures of the pores of the base layer, openings of the filtration layer, and pores of the growing media support layer cooperate to permit flow of liquid from the growing media support layer through the base layer and form a gas flow gradient throughout the multilayer assembly. The gas flow gradient permits passage of gas from the base layer to the growing media support layer to mitigate moisture accumulation at the base layer.

### RELATED APPLICATION

This application claims benefit of U.S. Provisional Patent Application No. 61/328,109, filed Apr. 26, 2010.

### COPYRIGHT NOTICE

© 2011 CGT, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This disclosure relates to vegetated eco-systems in the field of vegetated roof and vertical plane coverings and, in particular, to a multilayer assembly of fluid permeable geomatrix material for providing stormwater runoff management and protective vegetation on rooftops and vertical wall structures.

### BACKGROUND INFORMATION

The type of roof covering that is used on a building or dwelling can have a dramatic impact on the living conditions inside. For example, roof coverings that provide significant solar energy collection and remission can reduce the amount of heat energy conducted into the living area of a building and thereby lead to reduced energy costs (costs associated with cooling the living area) during hot periods. One type of roof covering that has received significant interest recently is a so-called “green roof” system. Green roof systems typically incorporate some type of vegetation in a roof covering. Green roof systems can lead to reduced energy costs, as a consequence of insulating evapotranspiration effects of the vegetation; reduced stormwater runoff, because of the water-absorbing nature of the vegetation and accompanying soil; and environmental advantages, resulting from increased green space in commercial or other populated areas.

One prior art roof covering is described in U.S. Pat. No. 6,606,823 to McDonough, et al. (“McDonough”). McDonough describes a roof covering system that includes modular trays for use in holding vegetation, absorbent material, or solar cells. The trays described by McDonough require several layers of different materials, as well as some type of ballast to weigh down the trays. Moreover, the McDonough trays have a complicated, expensive puzzle-type interlocking frame that leaves a gap between adjacent trays. These gaps represent uncaptured roof area that does not offer the benefits of the green roof system. The gaps between the trays also allow soil mixture to spill out of the trays and onto a frame position between the trays. This spilled soiled mixture can lead to water pooling underneath the roofing system and subsequent damage to the roof below the roofing system.

Another prior art green roof system is described in U.S. Pat. No. 6,862,842 to Mischo (“Mischo”). Mischo describes a modular green roof system that includes pre-seeded panels having edge flanges for connection purposes. The flanges of adjacent trays laterally abut or rest on top of each other and must be screwed or bolted together to secure the adjacent trays. The edge flanges space the trays apart. The screw- or bolt-type connections can add significant time and expense to the installation of the Mischo system. Consequently, a roofing system that does not require screwed or bolted connections between adjacent trays is desired.

### SUMMARY OF THE DISCLOSURE

The disclosure provides a multilayer assembly for use in a vegetated eco-roof or wall system. The multilayer assembly includes layers of progressively permeable geomatrix material. A base layer has first and second major surfaces that define an interior of the base layer. The base layer is characterized by compressive strength and by pores of sufficient sizes through which gas can pass and liquid can drain from one to the other of the first and second surfaces. A growing media support layer of porous material is characterized by sufficiently high strength to support solid root structure formation of vegetation growing in the growing media and by pores of sizes that cause liquid retention by and drainage from the support layer and permit passage of gas through the support layer. A filtration layer of preferably a nonwoven type is positioned between the base layer and the growing media support layer. The filtration layer is characterized by biaxial strength to preserve the structural integrity of the assembly and by openings sufficiently large to allow drainage of rainwater and excess irrigation water. The filtration layer retards the migration of soil fines from the drain field to the base layer. The filtration layer also establishes, for a liquid, a flow path to and, for a gas, an upward flow path from the base layer. The sizes and structures of the pores of the base layer, openings of the filtration layer, and pores of the support layer cooperate to permit flow of liquid from the growing media support layer through the base layer and form a gas flow gradient throughout the multilayer assembly. The gas flow gradient permits passage of gas from the base layer to the growing media support layer to mitigate moisture accumulation at the base layer.

Additional aspects and advantages will be apparent from the following detailed description of preferred embodiments, which proceeds with reference to the accompanying drawings.

### BRIEF DESCRIPTION OF THE DRAWINGS

FIG. 1 is an enlarged exploded cross-sectional review showing, from top to bottom, a growing media support layer, filtration layer, and drainage/aeration layer of the disclosed multilayer assembly for use in a vegetated eco-system.

FIG. 2 is an exploded isometric view of the multilayer assembly of FIG. 1 shown supporting plant and growing media layers and applied to a waterproof protective membrane.

FIGS. 3A and 3B are respective fragmentary top plan and perspective views of a roof surface on which is placed the multilayer assembly of FIGS. 1 and 2 filling an open space between two noncontiguous sets of empty interconnected eco-system roof trays.

### DETAILED DESCRIPTION OF PREFERRED EMBODIMENTS

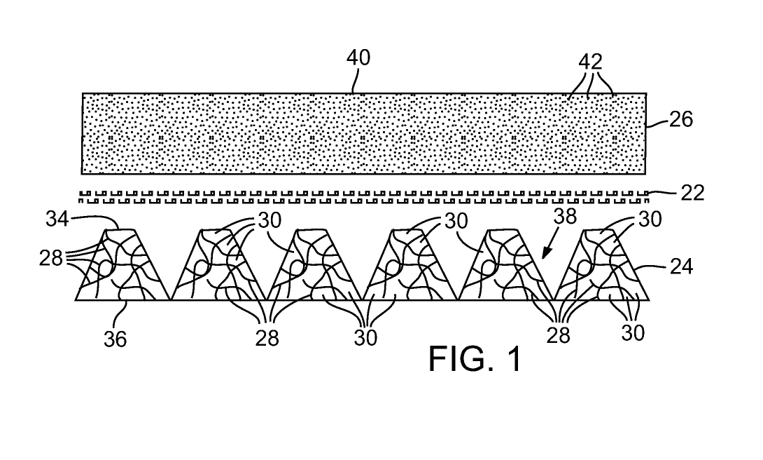

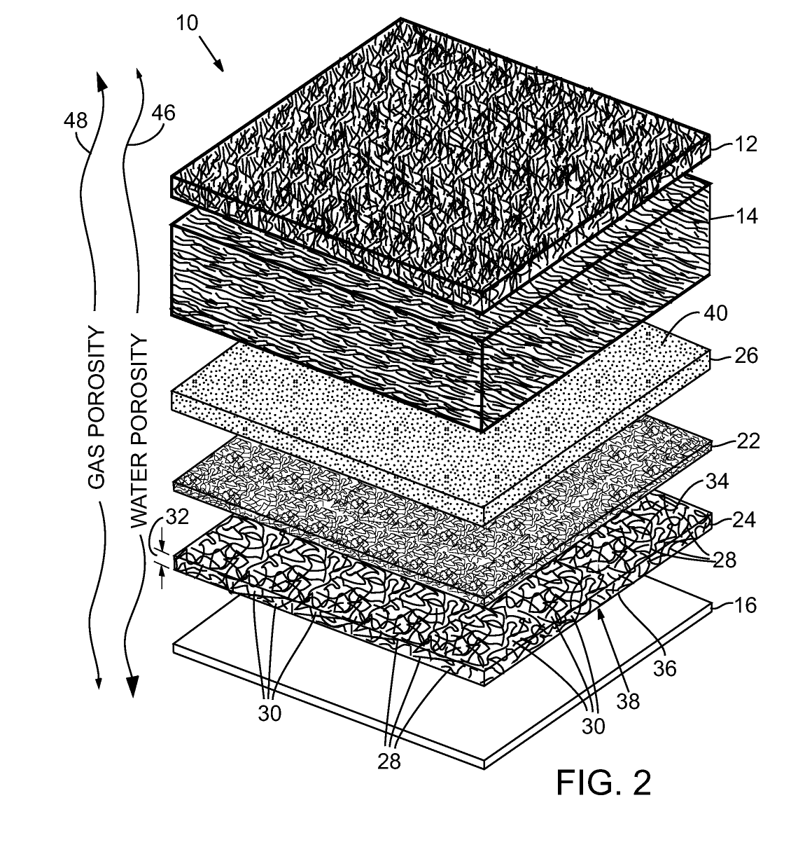

FIG. 1 is an enlarged exploded cross-sectional view of a multilayer assembly 10 of geomatrix material for use in a vegetated eco-system applied to horizontal roof or pitched roof structures or to vertical wall structures. FIG. 2 is an exploded isometric view of multilayer assembly 10 shown supporting vegetation including a plant layer 12 atop a growing media layer 14 and applied to a standard roofing or wall structure waterproof protective membrane 16. With reference to FIGS. 1 and 2, multilayer assembly 10 includes a filtration layer 22 positioned between a three-dimensional drainage/aeration base layer 24 and a growing media support layer 26. The support functions performed by layer 26 includes liquid retention and plant anchoring. Layers 22, 24, and 26 cooperate to develop progressive incremental liquid (i.e., water) infiltration rates in one direction (from layer 26 to layer 24) and aeration in the opposite direction (from layer 24 to layer 26).

Base layer 24 is an extruded polymer matrix of tangled monofilaments or strands 28. The polymer matrix is heat welded at its junctions to form a strong egg crate-shaped structure. Polymer strands 28 are woven in an entangled porous mesh that is characterized by compressive strength and large scale pores 30. Polymer strands 28 are arranged so that the entangled mesh of base layer 24 is of generally uniform thickness 32 and defines a discontinuous but generally planar upper major surface 34 and a discontinuous but generally planar lower major surface 36. The region between upper major surface 34 and lower major surface 36 of base layer 24 defines its interior 38. The spaces between strands 28 define pores 30 of sufficient sizes through which gas (e.g., air or water vapor) can pass within interior 38 in transverse and lateral directions relative to, and liquid can drain from one to the other of, upper major surface 34 and lower major surface 36. A preferred base layer 24 is a Driwall™ mortar deflection product, available from Keene Building Products, Mayfield Heights, Ohio. An alternative base layer 24 is a Mortar Break® mortar deflection device, available from Advanced Building Products, Inc., Springvale, Me. The Mortar Break® device is a polymer core geomatrix of polypropylene strands woven into an 0.8 in (20 mm)-thick mesh. (The mesh thickness of this product is not an exact required dimension.)

Filtration layer 22 is a flexible continuous-filament fabric that rests on upper major surface 34 of base layer 24. Filtration layer 22 is characterized by biaxial strength to preserve the lateral structural integrity of multilayer assembly 10 and by openings of sizes through which gas can pass and drainage water can freely pass. The biaxial strength of filtration layer 22 supports base layer 24 and growing media support layer 26, both of which can stretch laterally. A preferred filtration layer 22 is a Typar® Premium Landscape Fabric, available from The DeWitt Company, Sikeston, Mo. The Typar® product is a lightweight nonwoven polypropylene fabric that breathes. A nonwoven filtration layer is advantageous because it has differential opening sizes at any angle. The nonuniform cross-sectional opening structure ensures the presence of a flow path for gas or liquid. Depending on the angle of inclination of a support on which the filtration layer rests, a woven filtration layer exhibits different effective opening aperture sizes. A sufficiently steep inclination angle could cause effective occlusion of fluid flow through the fabric openings. In the case of liquids, adherence resulting from surface tension would cause restriction of flow through the fabric openings.

The nonwoven pattern structure and number of component layers of filtration layer 22 contribute to air flow and liquid flow (e.g., precipitation drainage or excess irrigation water). Capillary flow of liquid in filtration layer 22 preferably is established by filaments arranged in a circular pattern in the fabric to set the irrigation schedule. The specific flow rate of filtration layer 22 is measured in liquid flow rate expressed as flux in gallons/minute/square foot (gal/min/ft²). In general, higher specific flow rates are associated with larger opening sizes. For example, a high liquid flow rate (e.g., 120-150 gal/min/ft² (4,890-6,110 l/m/m²)) is produced by a larger average opening size that would permit larger soil fines to pass through than would a flow rate lower than 85 gal/min/ft² (3,465 l/m/m²). Moreover, a high liquid flow rate (produced by larger mean opening size) serves to prevent an agglomeration of soil, organic matter, and bio-organisms from forming an occlusive or a clogging boundary (bio-fouling) on a filtration layer 22. A low liquid flow rate (e.g., 85 gal/min/ft² (3,465 l/m/m²)) produced by a finer opening structure would more likely become clogged with such an agglomeration.

The irrigation schedule (i.e., the rate, duration, and periodicity of applied water) selected depends on the precipitation history of the geographic region where multilayer assembly 10 would be installed. A filtration layer 22 of coarser and finer opening structures would be used in geographic regions undergoing, respectively, larger amounts and smaller amounts of annual rainfall. A preferred Typar® Premium Landscape Fabric of 0.0115 in (0.29 mm) thickness and 0.0204 in (0.52 mm) opening has a specified flux of 200 gal/min/ft² (8,150 l/m/m²) and air permeability of 0.1 cm/sec. This is an appropriate filtration layer 22 for wetter climates. A 120 gal/min/ft² (4,890 l/m/m²) is available and appropriate for drier climates. An alternative filtration layer 22 is a 600 Series-Professional Choice or a 295 Series-Architect's Choice fabric, available from Ground Cover Industries, Inc., Arlington, Tex.

Growing media support layer 26 is a flexible, high strength porous fiber mat that overlays filtration layer 22 and supports growing media layer 14 deposited on an upper surface 40 of support layer 26. The growing media may be soil, Seal of Testing Assurance (STA)-approved compost, FLL-guideline green roof media, or other media commonly used for green roof applications. Support layer 26 is designed for liquid retention and drainage and anchorage points for promoting remediation and solid root structures for plants. Support layer 26 is characterized by sufficiently high strength to support solid root structure formation of vegetation growing in the growing media deposited on upper surface 40 and by sizes of pores 42 that cause liquid retention by drainage from support layer 26 and permit passage of gas through support layer 16. A preferred support layer 26 is a SandMat® 200 geosynthetic bunker liner, available from Milliken & Company, Spartanburg, S.C. The SandMat® 200 is a 0.5 in (13 mm)-thick blanket-like nonwoven geosynthetic lining made of high loft, high tensile polyester fibers resin-bonded with a water nonsoluble polymer for subgrade separation and drainage. The specified flux is 250 gal/min/ft² (10,190 l/m/m²). The growing media, such as soil, deposited on support layer 26 remains friable so that growing roots break up in the soil at the surface to keep intact the air flow passages established by pores 42. An alternative support layer 26 is a Sandtrapper™ fiber mat, available from IVI-GOLF, Johnson City, N.Y.

Large scale pores 30 of base layer 24, the openings established by the nonwoven pattern structure of filtration layer 22, and the pores of support layer 26 cooperate to permit flow of liquid from support layer 26 through base layer 24, in the direction indicated by the larger arrow head of a wavy line 46 (FIG. 2), and form a gas flow gradient to permit passage of gas from base layer 24 to support layer 26 and thereby mitigate moisture accumulation at base layer 24, in the direction indicated by the larger arrow head of a wavy line 48 (FIG. 2). (The smaller arrows heads appearing at the ends of wavy lines 46 and 48 indicate minor, oppositely directed gas and liquid flow paths.) In short, multilayer assembly 10, unlike prior art systems, enables gas or air flow from underneath base layer 24 and upward through support layer 26 to dry out protective membrane 16 on a rooftop. A typical rooftop protective membrane 16 on which multilayer assembly 10 is placed is made of polyvinyl chloride (PVC) roof membrane, ethylene propylene (TPO) rubber, or ethylene propylene diene terpolymer (EPDM) rubber material. Protective membrane 16 functions as a roof barrier layer that contributes to keeping the roof area dry and providing air flow. Prior art drainage systems do not permit sufficient upwardly directed air flow from the rooftop protective layer to the growing media.

### EXAMPLE

The following example is a preferred multilayer assembly 10 that is composed of layers 22, 24, and 26 matched for removal of excess rain or irrigation water while enabling the growing media to retain its natural stability of moisture. Filtration layer 22 and base layer 24 do not support mold.

Filtration layer 22 has the properties listed in Table 1 below.

TABLE 1

| | Typical Value | |
|---|---|---|
| Physical Properties | | |
| Tensile Strength | 73 lbs | (33 kg) |
| Stiffness | 24 lbs | (11 kg) |
| (IFS @ 50%) | | |
| Drainage Performance | | |
| Permittivity | 3 | Sec |
| Flow Rate | 200 GPM/SF | (8,000 LPM/M²) |
| Permeability | 10 × 10⁻² | cm/sec |
| Roll Data | | |
| Roll Width | 75 in | (190.5 cm) |
| Roll Length | 300 ft | (91.4 m) |
| Roll Weight | 25 lbs | (11.3 kg) |

Base layer 24 has the properties listed in Table 2 below.

TABLE 2

| | Test Method | Typical Value | |
|---|---|---|---|
| Physical | | | |
| Properties | | | |
| Flame Spread | ASTM E84 | Class A | |
| Core Polymer | | Polypropylene or Nylon, | |
| | | UV-Stabilized | |
| Thickness | | 0.75 in (19 mm) or | |
| | | 1.5 in (38 mm) | |
| Total Weight | | 16.7 oz/yd² | (631 g/m²) |
| Drainage | | | |
| Performance | | | |
| Flow Rate | | Greater than 10 gpm | |
| | | (37.85 lpm) | |
| Permeability | ASTM E 283 | 50 CFM | (6 cm/s) |
| Roll Data | | | |
| Roll Width | N/A | 48 in | (122 cm) |
| Roll Length | N/A | 50 ft | (15.2 m) |
| Roll Weight | N/A | 29 lbs | (13.2 kg) |
| Dry Weight Per | N/A | .145 lbs/SF | (.70 kg/M²) |
| SF (M²) | | | |
| Fully Saturated | N/A | .145 lbs/SF | (.70 kg/M²) |
| Weight Per SF (M²) | | | |

| | |
|---|---|
| Slopes | 2/12 Plus |

Support layer 26 has the properties listed in Table 3 below.

TABLE 3

| | |
|---|---|
| Test Method | Typical Value |

Physical
Properties

| Thickness | ASTM D5376 | 1 in | (25.0 mm) |
|---|---|---|---|
| Tensile Strength | ASTM D5035 | 31 lbs | (14 kg) |
| Stiffness | ASTM D3776-96 | 24 lbs | (11 kg) |
| (IFS @ 50%) | | | |
| Drainage | | | |
| Performance | | | |
| Permittivity | ASTM D5493 | 3.5 | Sec |
| (4.8 kPa) | | | |
| Flow Rate | ASTM D5493 | 220 GPM/SF | (9,000 LPM/M²) |
| (4.8 kPa) | | | |
| Permeability | ASTM D5493 | 32 CFM | (4 cm/s) |
| (4.8 kPa) | | | |
| Roll Data | | | |
| Roll Width | N/A | 116 in | (2.95 m) |
| Roll Length | N/A | 75 ft | (22.9 m) |
| Roll Weight | N/A | 63 lbs | (28.6 kg) |
| Dry Weight Per | N/A | .087 lbs/SF | (.42 kg/M²) |
| SF (M²) | | | |
| Fully Saturated | N/A | 1.5 lbs/SF | (7.31 kg/M²) |
| Weight Per SF (M²) | | | |

| | |
|---|---|
| Slopes | 2/12 Plus |

Industry standard absorption capacity and wet weight test methods for nonwoven fabrics were carried out for five each of layers 22, 24, and 26 cut into 24 in×24 in (61 cm×61 cm) pieces. The recorded information for dry weight was less than 0.15 lb/ft² (0.732 kg/m²) for layers 22, 24, and 26. The recorded information for absorption rate time was less than 5 seconds for base layer 24 and filtration layer 22. The absorption rate time for support layer 26 averaged 4.25 minutes. The recorded information for wet weight was less than 0.125 lb/ft² (0.610 kg/m²) per square foot for base layer 24 and filtration layer 22. The wet weight (fully saturated) for support layer 26 averaged 1.8 lb/ft² (8.788 kg/m²). The recorded information for absorption capacity was nil for base layer 24 and filtration layer 22. The absorption capacity for support layer 26 averaged 1.6 lb/ft² (7.812 kg/m²).

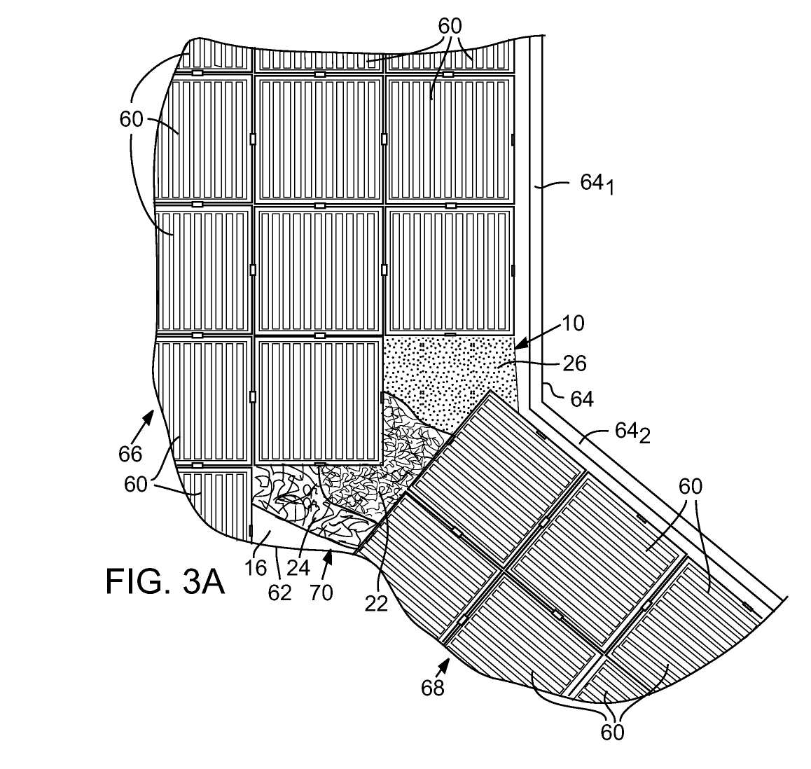

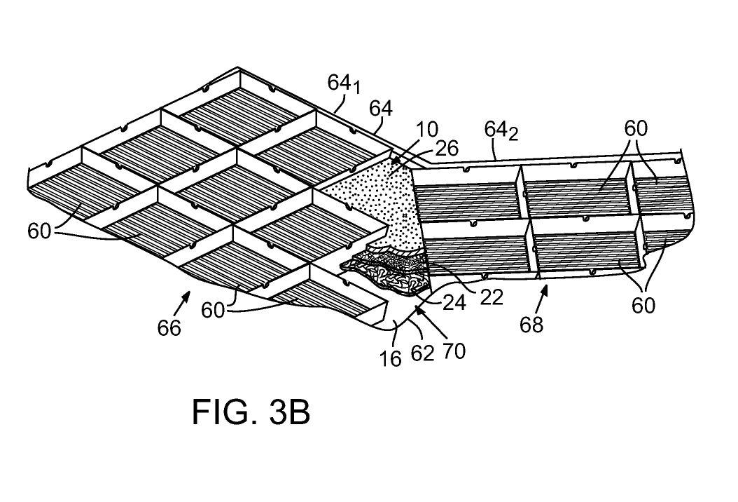

FIGS. 3A and 3B show multiple interconnected roofing trays 60 of the same rectangular shape and size applied to a flat rooftop 62 having an angled front roof line 64. Roofing trays 60 are of the type described in U.S. Pat. Nos. 7,726,071 and 7,603,808. A first set 66 of interconnected trays 60 is aligned with roof line section 64₁, and a second set 68 of interconnected trays 60 is aligned with a roof line section 64₂. The corner junction of roof line sections 64₁ and 64₂ causes formation of an open space or gap 70 of irregular shape between the confronting unconnected sides of trays 60 in first and second sets 66 and 68. Multilayer assembly 10 can be used as an interface between rooftop trays 60 wherever it is impracticable to interconnect them.

Trays 60 contain vegetation in an eco-roof system, and multilayer assembly 10 sized to fit within open space 70 provides uniform roof top vegetation coverage. FIGS. 3A and 3B present depthwise views of multilayer assembly 10 to show placement of its individual component layers 22, 24, and 26. A complete vegetative roof system includes plant layer 12 and growing media layer 14 in trays 60 and on top of multilayer assembly 10.

Skilled persons will appreciate that multilayer assembly 10 can be used to conformably fit around ventilation pipes and other appurtenances protruding from the roof surface, as well as provide a buffer region between interconnected tray sets and rooftop structures.

One or more of layers 22, 24, and 26 of multilayer assembly 10 retain and detain the flow of stormwater runoff or excess irrigation water and thereby enable water discharge flow and pollution management. Vegetation mitigates particulate air pollution. Stormwater retention keeps rainwater on the roof surface for losses by evapotranspiration. This reduces the total volume of runoff to the urban drainage systems, decreases stream damage or loads on wastewater treatment plants, and reduces the incidences of combined sewer overflows. Stormwater detention attenuates peak flows and reduces the incidence of flooding and destruction of natural stream corridors. A nonporous mat positioned beneath a growing media support layer retains water and, when wet, traps air. A lack of air flow produces anaerobic bacteria, which are undesirable; whereas multilayer assembly 10 produces aerobic bacteria, which are desirable, at growing media support layer 26.

It will be obvious to those having skill in the art that many changes may be made to the details of the above-described embodiments without departing from the underlying principles of the invention. The scope of the present invention should, therefore, be determined only by the following claims.

1. A multilayer assembly of fluid permeable geomatrix material for use in a vegetated eco-system, comprising:
a base layer having first and second major surfaces that define an interior of the base layer, the base layer characterized by compressive strength and by pores of sufficient sizes through which gas can pass and liquid can drain from one to the other of the first and second surfaces;
a growing media support layer of high strength porous material, the support layer characterized by sufficiently high strength to support solid root structure formation of vegetation growing in the growing media and by pores of sizes that cause liquid retention by and drainage from the support layer and permit passage of gas through the support layer;
a filtration layer positioned between the base layer and the growing media support layer, the filtration layer characterized by biaxial strength to preserve structural integrity of the multilayer assembly and by openings of sizes and structure to allow drainage of rain and excess irrigation water while retarding migration of soil and occurrence of biological fouling; and
the sizes and structures of the pores of the base layer, openings of the filtration layer, and pores of the support layer cooperating to permit flow of liquid from the growing media support layer through the base layer and forming a gas flow gradient throughout the multilayered assembly to permit passage of gas from the base layer to the growing media support layer to mitigate moisture accumulation at the base layer.

2. The multilayer assembly of claim 1, in which the filtration layer is of a nonwoven type.

3. The multilayer assembly of claim 1, in which the base layer comprises strands woven in an entangled mesh having generally planar first and second major surfaces that define an interior of the entangled mesh, the entangled mesh characterized by compressive strength and by pores of sufficient sizes through which gas can pass within the interior in transverse and lateral directions relative to the first and second major surfaces and through which liquid can drain from one to the other of the first and second surfaces.

4. The multilayer assembly of claim 1, in which the growing media support layer includes a nonwoven matrix of fibers.

5. A vegetation roofing system, comprising:
a first set of multiple interconnected trays, the first set including trays having side walls that are unconnected to other trays in the first set;
a second set of multiple interconnected trays, the second set including trays having side walls that are unconnected to other trays in the first set;
the first and second sets arranged so that at least some of the unconnected side walls of the trays in the first set confront and are spaced-apart from at least some of the unconnected side walls of trays in the second set to provide an open space between the first and second sets; and
a multilayer assembly of fluid permeable geomatrix material positioned in the open space, the multilayer assembly including
a base layer having first and second major surfaces that define an interior of the base layer, the base layer characterized by compressive strength and by pores of sufficient sizes through which gas can pass and liquid can drain from one to the other of the first and second surfaces;
a growing media support layer of high strength porous material, the support layer characterized by sufficiently high strength to support solid root structure formation of vegetation growing in the growing media and by pores of sizes that cause liquid retention by and drainage from the support layer and permit passage of gas through the support layer;
a filtration layer positioned between the base layer and the growing media support layer, the filtration layer characterized by biaxial strength to preserve structural integrity of the multilayer assembly and by openings of sizes and structure to allow drainage of rain and excessive irrigation water while retarding migration of soil and occurrence of biological fouling.

6. The vegetation roofing system of claim 5, in which the filtration layer is of a nonwoven type.

7. The vegetation roofing system of claim 5, in which the base layer comprises strands woven in an entangled mesh having generally planar first and second major surfaces that define an interior of the entangled mesh, the entangled mesh characterized by compressive strength and by pores of sufficient sizes through which gas can pass within the interior in transverse and lateral directions relative to the first and second major surfaces and through which liquid can drain from one to the other of the first and second surfaces.

8. The vegetation roofing system of claim 5, in which the growing media support layer includes a nonwoven matrix of fibers.
